(19) United States
(12) Patent Application Publication
(10) Pub. No.: US 2017/0190557 A1
(43) Pub. Date: Jul. 6, 2017

(54) Auto release safety spear for preassurized beverage containers

(71) Applicants: Aric Randal Dean, Bend, OR (US); Don Angell, Bend, OR (US)

(72) Inventors: Aric Randal Dean, Bend, OR (US); Don Angell, Bend, OR (US)

(21) Appl. No.: 15/370,340

(22) Filed: Dec. 6, 2016

Related U.S. Application Data
(60) Provisional application No. 62/268,086, filed on Dec. 16, 2015.

(51) Int. Cl. B67D 1/08; B25B 13/50; B25B 27/24

(52) U.S. Cl. CPC B67D 1/0809; B25B 27/24; B25B 13/50; B67D 2001/0822; F16L 15/006

(57) ABSTRACT

The invention relates to a modified valve apparatus that resides on/in a pressurized vessel/container in which automatically releases pressure upon removal using a specialized tool, thus reducing the possibility for bodily/property damage as well as allowing access into the vessel/container.

### BACKGROUND OF THE INVENTION

Field of the Invention

The invention relates generally to an automated pressure relief system for the safe removal of threaded tube/coupler systems in/on the pressurized beverage containers. More specifically, the invention relates to a modified beverage expulsion/valve apparatus that will automatically release any interior pressure upon the removal of the apparatus with a specific tool—which reduces the possibility of premature ejection of the said apparatus and thus bodily harm.

Description of the Related Art

It is perilous and difficult to remove any threaded ‘stopper device’ and/or valve from a pressurized container. If the person attempts to remove a threaded device and/or valve while the contents of the container is under pressure the device and/or valve may (and can) eject out of the container in which it resides and can cause bodily harm as well as property destruction. This is especially problematic with containers classified as ‘kegs’ which can hold all types of liquids and other material.

This problem exists because the current available apparatus/valve systems do not allow for a fail-safe system for removing the apparatus/valve to gain access to the inside of the container.

### SUMMARY OF THE INVENTION AND ADVANTAGES

The subject invention comprises a method and apparatus for automatically releasing any interior pressure of a container upon the removal of the apparatus while allowing for normal apparatus operation.

Using a specific tool, the user can remove the threaded valve apparatus from the container and if there is any pressure inside the vessel/container the threaded valve apparatus will release an audible sound (which is caused by the release of pressure).

The release of the pressure allows for the safe removal of the threaded valve apparatus and gain access to the interior of the pressurized container.

### BRIEF DESCRIPTION OF THE DRAWINGS

These and other features and advantages of the present invention will become more readily appreciated as the same becomes better understood by reference to the following detailed description when considered in connection with the accompanying drawings wherein:

FIG. 1 is a cross-section perspective view showing the valve apparatus that is in common use and is of standard form (free of any vessel/container) with the pressure relief ports.

FIG. 2 is a cross-section perspective view representing the valve apparatus that is in common use and is of standard form in which is inserted (threaded) into a vessel/container (including pressure relief ports) to represent the apparatus in use.

FIG. 3 is a drawing representing the specialized tool used to remove the valve apparatus and how it fits onto a standard socket wrench.

FIG. 4 is a drawing representing an angled, top view, of the specialized tool and a properly installed valve apparatus showing how the end user can remove and insert the valve apparatus using the tool.

### DETAILED DESCRIPTION OF THE PREFERRED EMBODIMENT

Referring to the Figures, wherein like numerals indicate like or corresponding parts throughout the several views as follows:

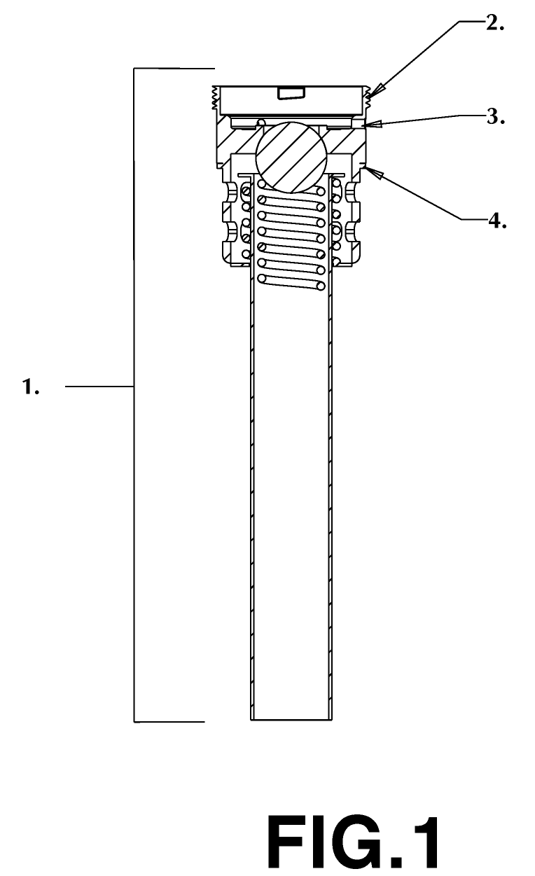

FIG. 1 in this cross-section perspective of the valve apparatus 1 that is threaded 2 and modified with pressure relief ports 3 that automatically releases any pressure once the seal 4 is broken.

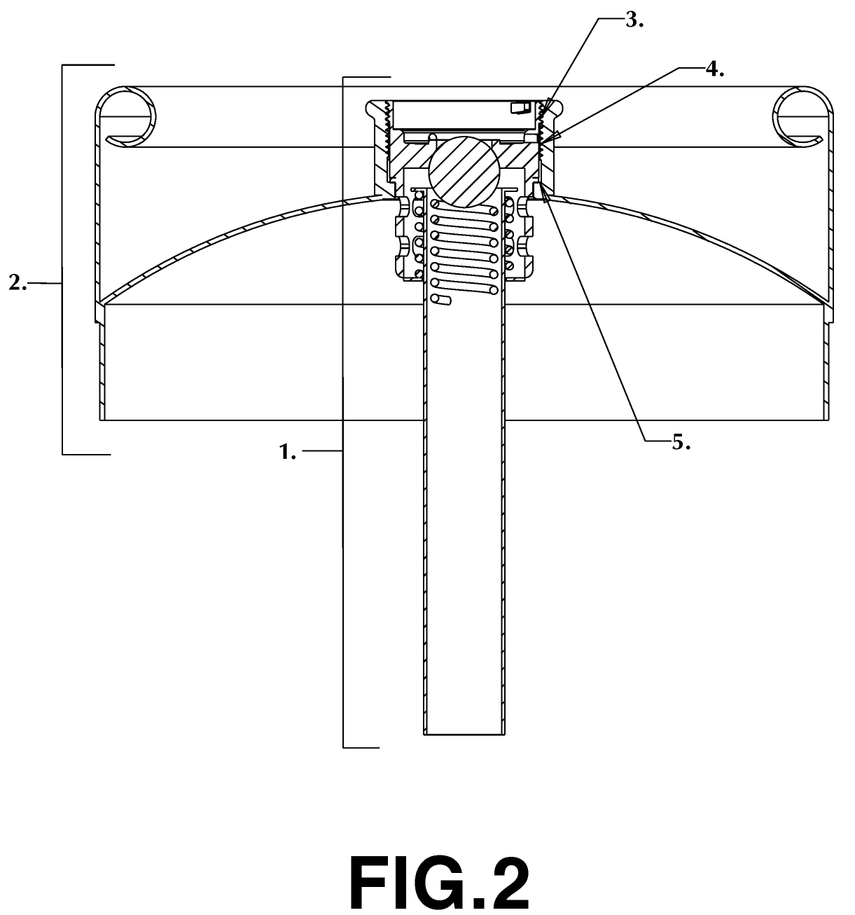

FIG. 2 in this cross-section perspective the valve apparatus 1 properly threaded 3 into the vessel/container with the seal 5 properly sealing the pressure relief ports 4.

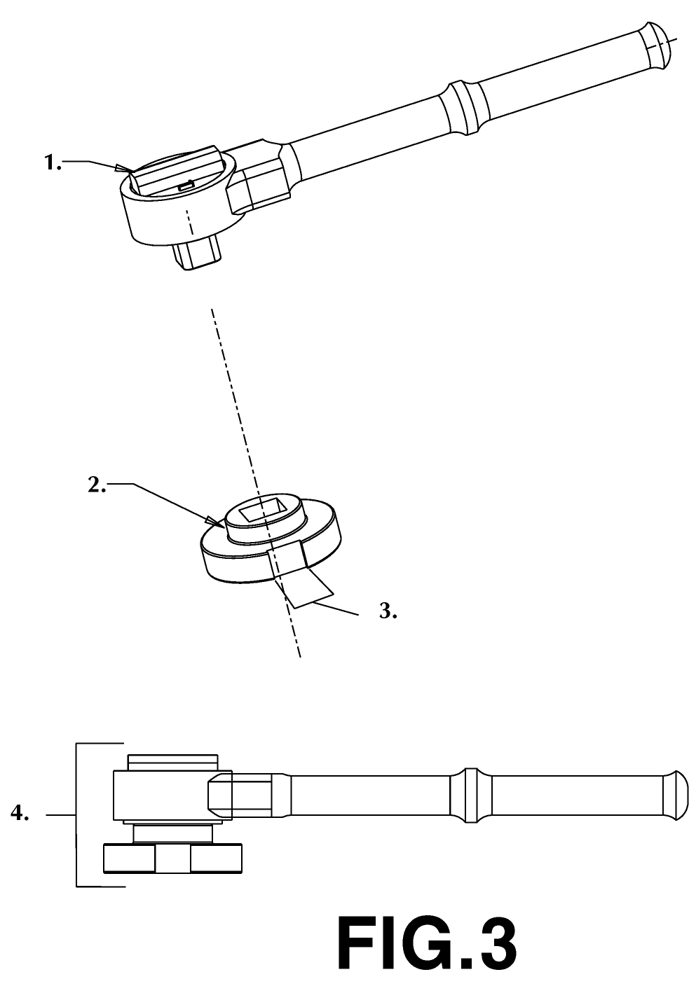

FIG. 3 represents a standard socket wrench 1 and the tool 2 with keyway tab cutaways 3 combined to form the manner in which the two items are assembled 4.

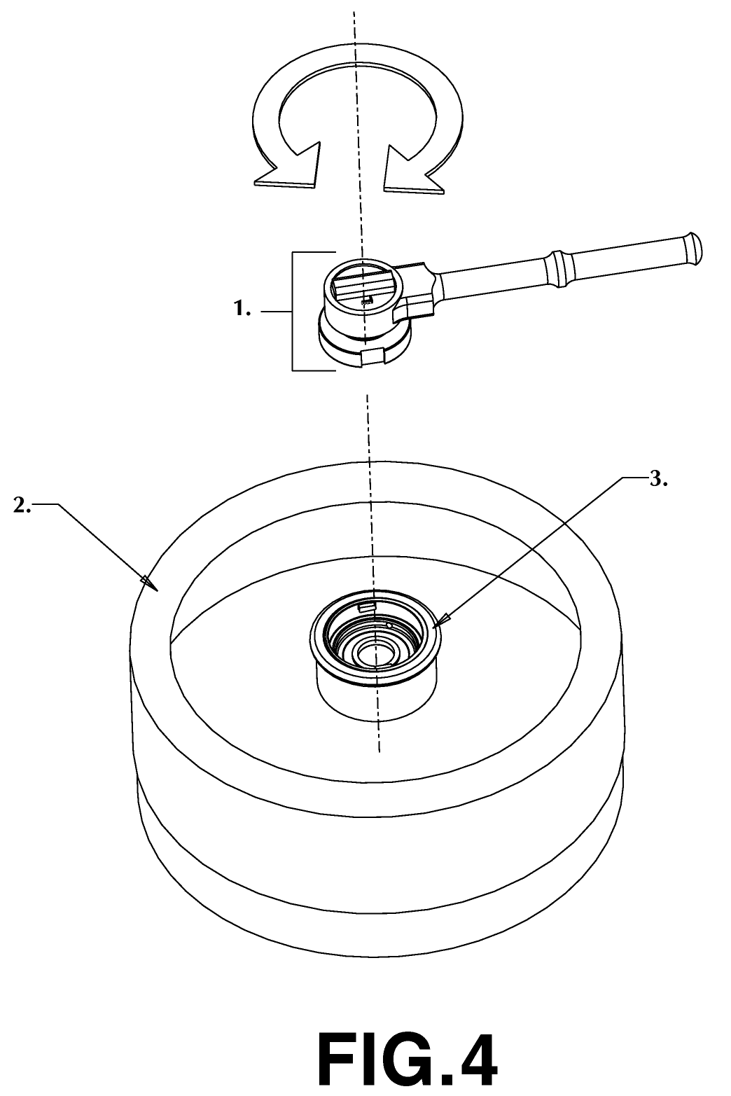

FIG. 4 shows an elevated side view of a vessel/container 2 with a properly installed valve apparatus 3 and the specialized tool assembly 1 and the motion in which the valve apparatus 3 is inserted (clockwise rotation) and removed (counter-clockwise rotation).

1. A safety valve apparatus that resides in a pressurized container that automatically relatives any pressure (from inside the vessel/container) when removed using the described tool assembly is substantially shown and described herein.
